(19) United States
(12) Patent Application Publication
(10) Pub. No.: US 2013/0147606 A1
(43) Pub. Date: Jun. 13, 2013

(54) RADIO FREQUENCY IDENTIFICATION READER AND SYSTEM

(71) Applicants: HSIN-PEI CHANG, New Taipei (TW); ZONG-YUAN SUN, New Taipei (TW); DA-HUA XIAO, Shenzhen (CN)

(72) Inventors: HSIN-PEI CHANG, New Taipei (TW); ZONG-YUAN SUN, New Taipei (TW); DA-HUA XIAO, Shenzhen (CN)

(21) Appl. No.: 13/677,322

(22) Filed: Nov. 15, 2012

(30) Foreign Application Priority Data
Dec. 8, 2011 (CN) 201110405843.6

(51) Int. Cl. H04B 5/00

(52) U.S. Cl. CPC H04B 5/0062
USPC 340/10.1

(57) ABSTRACT

A radio frequency identification (RFID) reader includes a main body, a first connecting portion, and a second connecting portion. The first connecting portion and the second connecting portion are positioned at two sides of the main body. The first connecting portion is configured to connect to the second connecting portion of another RFID reader and interconnecting the RFID reader to another RFID reader in series.

### BACKGROUND

1. Technical Field

The disclosure generally relates to radio frequency identification (RFID) technology, and particularly to a RFID reader and system.

2. Description of Related Art

RFID technology is an automatic identification technology based on radio frequency identification principle and is widely used in various fields to track people and articles. A RFID system commonly includes a plurality of RFID tags, a RFID reader and a data processor. Each RFID tag is configured to store article or personal information. The RFID reader communicates with the RFID tags and reads the information stored in the RFID tags.

However, most RFID readers can identify and read the RFID tag in a limited effective identifying area, but there is always a “blind area”. Referring to FIG. 4, an effective identifying area A10 of a typical RFID reader includes a primary identifying area A11 and two secondary indentifying area A12 symmetrically positioned at two sides of the primary identifying area A11. A blind area A13 is formed between each secondary indentifying area A12 and the primary identifying area A11. To reduce the blind area A13, multiple RFID readers are linearly positioned to enlarge the effective identifying areas and enhance identifying sensitivity. However, two adjacent RFID readers still cannot completely cover the blind area of each other so that a blind area A14 still exists.

Therefore, there is room for improvement within the art.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the disclosure.

FIG. 1 is a block diagram of a RFID system, according to an exemplary embodiment of the disclosure.

FIG. 2 is a partial circuit diagram of the RFID system of FIG. 1, according to an exemplary embodiment of the disclosure.

FIG. 3 is a radiation pattern of RFID readers of the RFID system of FIG. 1, according to an exemplary embodiment of the disclosure.

FIG. 4 is a radiation pattern of conventional RFID readers.

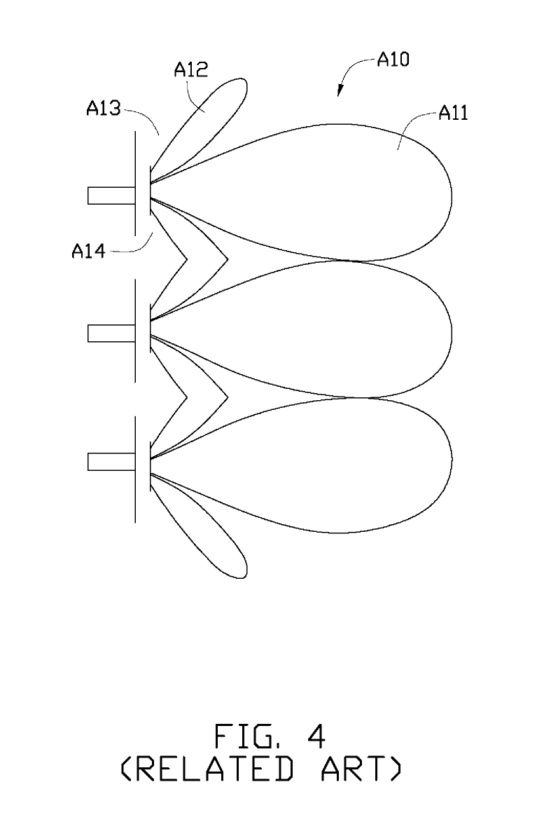

### DETAILED DESCRIPTION

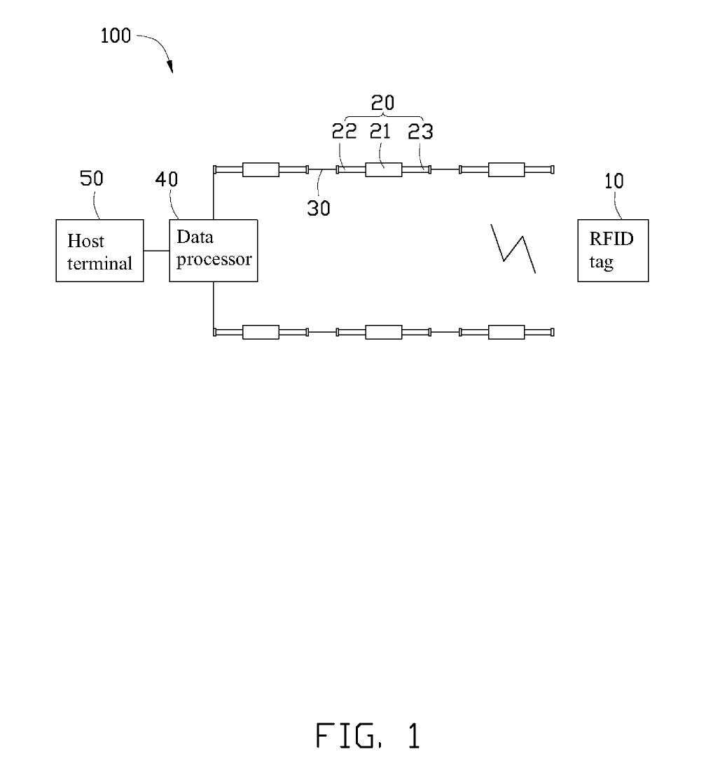

FIG. 1 is a block diagram of a RFID system 100, according to an exemplary embodiment of the disclosure. The RFID system 100 includes a plurality of RFID tags 10, a plurality of RFID readers 20, a data processor 40, and a host terminal 50.

Each RFID tag 10 includes an RFID microchip which stores personnel information such as names, work numbers or studying numbers of workers or students, for example.

Each RFID reader 20 includes a main body 21, a first connecting portion 22, and a second connecting portion 23. The first connecting portion 22 and the second connecting portion 23 are positioned at two opposite ends of the main body 21. The first connecting portion 22 and the second connecting portion 23 may be connectors.

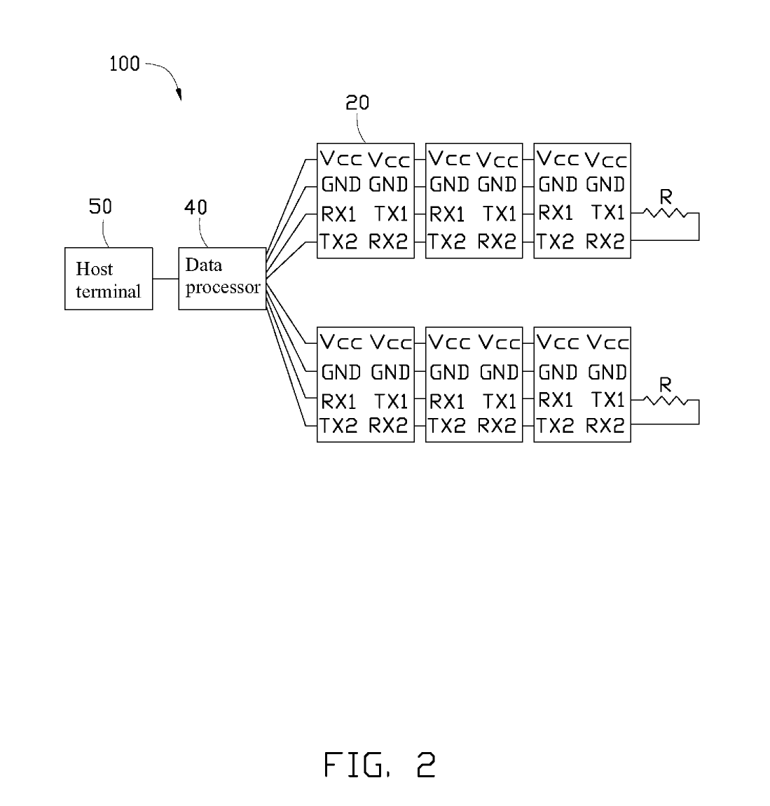

Referring to FIG. 2, the main body 21 of the embodiment is shown. The main body 21 includes two power supply contacts Vcc, two ground contacts GND, a first data receiving contact RX1, a first data transmitting contact TX1, a second data receiving contact RX2, and a second data transmitting contact TX2. One of the power supply contacts Vcc, one of the ground contacts GND, the first data receiving contact RX1, and the second data transmitting contact TX2 form a first connecting terminal The other one of the power supply contacts Vcc, the other one of the ground contacts GND, the second data receiving contact RX, and the first data transmitting contact TX1 form a second connecting terminal Each RFID reader 20 includes an identity (ID) number configured to distinguish the RFID reader 20 from other RFID readers 20.

The first connecting portion 21 and the second connecting portion 23 are conventional connectors configured to interconnect the RFID readers 20. The first connecting portion 21 connects to the first connecting terminal The second connecting portion 23 connects to the second connecting terminal

The RFID readers 20 are interconnected in series by a plurality of conductive lines 30. The first connecting terminal of an initial RFID reader 20 (i.e., an RFID reader 20 positioned at an end of the serially interconnected RIFD readers 20) is electrically connected to the data processor 40 via the first connecting portion 21. The second connecting terminal of the initial RFID reader 20 is electrically connected to the first connecting terminal of an adjacent RFID reader 20 (i.e., the RFID reader 20 directly connected to the initial RFID reader 20). The second connecting terminal of the adjacent RFID reader 20 is electrically connected to the first connecting terminal of an next RFID reader 20 (i.e., the RFID reader 20 directly connected to the adjacent initial RFID reader 20 excepting the initial RFID 20). The next RFID reader 20 and remaining RFID readers 20 are electrically connected in the same way similar to the adjacent RFID reader 20. The first data transmitting contact TX1 and the second data receiving contact RX2 of a distal RFID reader 20 (i.e. an RFID reader 20 positioned at another end of the serially interconnected RIFD reader 20) are shorted by a resistor having zero ohms Thus, all RFID readers 20 are connected in series to form a data transmitting link. All the RFID readers 20 can communicate with the data processor 40 via the data transmitting link.

In this exemplary embodiment, the RFID readers 20 are connected to form two data transmitting links. For the purpose of simplicity, in this exemplary embodiment, each data transmitting link includes three RFID readers 20 connected in series as one example.

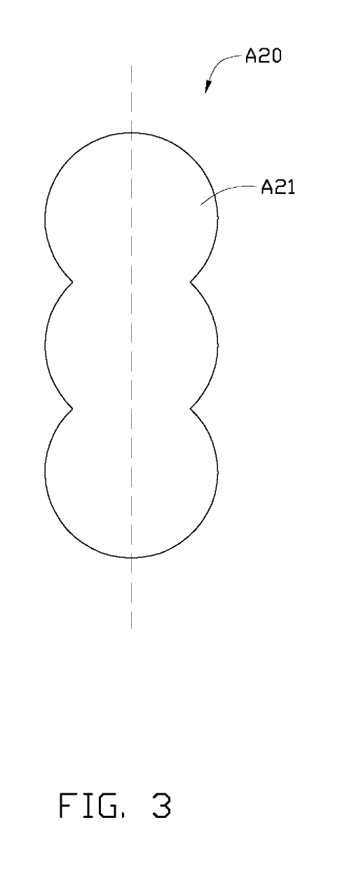

Referring to FIG. 3, each RFID reader 20 includes a substantial circle sub-identifying area. Portions of the identifying areas A21 of two adjacent RFID readers 20 overlap and form a complete main identifying area A20. The complete main identifying area A20 is an area having no blind areas between every two adjacent RFID readers 20. Thus, the entire effective identifying area of the RFID readers 20 is effectively enlarged. Moreover, blind areas which may exist between two adjacent RFID readers 20 are reduced and can be almost eliminated.

In addition, a length of each conductive line 30 interconnected two adjacent RFID readers 20 is substantially equal to a diameter of each identifying area A20. The length of each conductive line 30 can be adjusted to change the identifying area A20 according to requirement to identifying ability of the RFID readers 20.

The host terminal 50 may be a computer. The host terminal 50 obtains and manages the information of the RFID tags 10 indentified and read by the RFID readers 20 and the data processor 40. The host terminal 50 also sends commands to the RFID readers 20 by the data processor 40 to obtain information of the RFID readers 20 such as version numbers. In addition, the host terminal 50 has an identity (ID) number. The RFID readers 20 can send the information of the RFID tags 10 to the host terminal 50 according to the ID number of the host terminal 50.

To use the RFID system 100, the RFID readers 20 connected in series can identify and read the RFID tags 10 positioned in the main indentifying areas A20. For example, when the initial RFID reader 20 identifies one of the RFID tags 10 and reads the original information of the RFID tag 10, the initial RFID reader 20 processes the original information to be a data packet and transmits the data packet to the next RFID reader 20. The data packet may include an ID number of a transmitting part (i.e., RFID reader 20 here), an ID number of a target part (i.e., the host terminal 50 here) and the original information of the RFID tag 10. The adjacent RFID reader 20 receives the data packet. The adjacent RFID reader 20 can determine that the data packet is needed to be transmitted to the host terminal 50 according to the ID number of the target part and sends the data packet to the next RFID reader 20. The next RFID reader 20 and remaining RFID readers 20 operates substantially similar to the adjacent RFID reader 20 until the data packet is transmitted to the host terminal 50.

In addition, the host terminal 50 can send commands to the RFID readers 20. Each command may include an ID number of the target part (i.e., some RFID readers 20 here), command content (e.g., transmitting the version number to the host terminal 50), and a verifying code. For example, when the initial RFID reader 20 receives the command from the host terminal 50, the initial RFID reader 20 determines whether the command is aimed at itself according to the ID number of the target part. If the command is aimed at the initial RFID reader 20, the initial RFID reader 20 executes the command and transmits the command to the next RFID reader 20. If the command is not aimed to the initial RFID reader 20, the initial RFID reader 20 transmits the command to the next RFID reader 20 directly. The next RFID reader 20 and the remaining readers 20 operates substantially similar to the initial RFID reader 20 until the distal RFID reader 20 sends all executing data back to the host terminal 50.

In one exemplary embodiment, during the processes of transmitting the data packets and commands, to prevent signal intensities from being weakened due to transmission loss, each RFID reader 20 can strengthen the signal intensities by a voltage boosting process before transmitting the data packet and commands and weaken the signal intensities by a voltage reducing process when receiving the data packet and commands.

The RFID readers 20 interconnected in series of the RFID system 100 effectively enlarge the entire identifying area and reduces the blind areas that may be formed between adjacent RFID readers 20. Therefore, the information of the RFID tags 10 can be more accurately indentified and read the information of the RFID tags 10.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A radio frequency identification (RFID) reader, comprising:
a main body;
a first connecting portion; and
a second connecting portion; wherein the first connecting portion and the second connecting portion are positioned at two sides of the main body, the first connecting portion is configured to connect to the second connecting portion of another RFID reader and interconnecting the RFID reader to the another RFID reader in series.

2. The RFID reader of claim 1, wherein the main body comprises a first connecting terminal and a second connecting terminal; the first connecting terminal comprises a power supply contact, a ground contact, a first data receiving contact, and a second data transmitting contact; the second connecting terminal comprises a power supply contact, a ground contact, and a first data transmitting contact, and a second data receiving contact;
the first connecting terminal is electrically connected to the first connecting portion, the second connecting terminal is electrically connected to the second connecting portion.

3. A radio frequency identification (RFID) system, comprising:
a plurality of RFID tags storing personnel information;
a plurality of RFID readers identifying and reading the personnel information of the RFID tags; each RFID reader comprising:
a main body;
a first connecting portion; and
a second connecting portion; wherein the first connecting portion and the second connecting portion connects to two sides of the main body, the RFID readers interconnected in series by the first and second connecting portions and a plurality of conductive lines;
a data processor; and
a host terminal obtaining the personnel information of the RFID tags by the data processor.

4. The RFID system of claim 3, wherein the main body comprises a first connecting terminal and a second connecting terminal, the first connecting terminal comprises a power supply contact, a ground contact, a first data receiving contact, and a second data transmitting contact; the second connecting terminal comprises a power supply contact, a ground contact, and a first data transmitting contact, and a second data receiving contact; the first connecting terminal of each RFID reader is connected to the first connecting portion, the second connecting terminal of each RFID reader is connected to the second connecting portion.

5. The RFID system of claim 4, wherein the first connecting terminal of an initial RFID reader which is positioned at an end of the serially interconnected RIFD readers is connected to the data processor by the first connecting portion, the second connecting terminal of the initial RFID is electrically connected to the first connecting terminal of an adjacent RFID reader which is directly connected to the initial RFID reader; the second connecting terminal of the adjacent RFID reader is connected to the first connecting terminal of a next RFID reader which is directly connected to the adjacent initial RFID reader except for the initial RFID; the next RFID reader and remaining RFID readers are electrically connected in the same way similar to the adjacent RFID reader; the first data transmitting contact and the second data receiving contact of a distal RFID reader which is positioned at anther end of the serially interconnected RIFD readers are shorted by a zero ohm resistor.

6. The RFID system of claim 4, wherein each RFID comprises a substantially circle sub-identifying area, two adjacent identifying areas overlap and form a complete main identifying area, the complete main identifying area is an area having no blind areas between every two adjacent RFID readers.

7. The RFID system of claim 6, wherein a length of each conductive line interconnects two adjacent RFID readers is equal to a diameter of the sub-identifying area.

8. The RFID system of claim 6, wherein each RFID comprises a ID number, when one of the RFID reader identifies and reads original personnel information of one RFID tag, the RFID reader processes the original personnel information to be a data packet which comprises ID number of a transmitting part, an ID number of a target part and the original personnel information, the adjacent RFID reader receives the data packet, determines that the data packet needs to be transmitted to the host terminal according to the ID number of the target part and sends the data packet to the next RFID reader, the next RFID reader and remaining RFID readers operates substantially similar to the adjacent RFID reader until the data packet is transmitted to the host terminal.

9. The RFID system of claim 6, wherein the host terminal comprises an ID number, when the host terminal transmits a command which comprises an ID number of the target part, command content, and a verifying code to some of the RFID readers, the RFID readers executes the command and sends executing information back to the host terminal

10. The RFID system of claim 9, wherein each RFID reader strengthens signal intensities by a voltage boosting process before transmitting the data packet and commands and weakens the signal intensities by a voltage reducing process while receiving the data packet and commands.
